(19) United States
(12) Patent Application Publication
(10) Pub. No.: US 2013/0207506 A1
(43) Pub. Date: Aug. 15, 2013

(54) INSULATED STRUCTURE OF SHIELD TYPE MOTOR COIL

(71) Applicant: Fang-Fu CHANG, Taipei City (TW)

(72) Inventor: Fang-Fu CHANG, Taipei City (TW)

(21) Appl. No.: 13/371,942

(22) Filed: Feb. 13, 2012

(51) Int. Cl. H02K 3/34

(52) U.S. Cl. 310/215

(57) ABSTRACT

An insulated structure of shield type motor coil includes an iron core having a multiplicity of bobbins, at least a plastic shell having a multiplicity of insulators and is pressed against the iron core, a multiplicity of enamel-covered coils and each of the insulators is one-to-one correspondent to and pressed against the bobbin, a multiplicity of enamel-covered coils each of them is correspondent to and wound around the bobbin and the multiplicity of enamel-covered coils has a first connecting lead and a second connecting lead extended there from, a wire fastener secured in the plastic shell for holding the first connecting lead and the second connecting lead, a protecting jacket connected to the plastic shell and having a containing space for containing the multiplicity of enamel-covered coils, as well as a supporting frame for coating the protecting jacket and having a multiplicity of supporting posts thereof.

### BACKGROUND OF THE INVENTION

1. Field of the Invention

The invention relates to an “insulated structure of shield type motor coil”, and more particularly, to an “insulated structure of shield type motor coil” that make use of a supporting frame for coating the protecting jacket, and also to provide a supporting frame that has a multiplicity of supporting posts which is capable of protecting the iron core from being damaged to generate deformation by the pressure during the teeming process into a mold, thereby to achieve a high efficacy of manufacturing yield.

2. Description of the Prior Art

The structure of a common shield type motor firstly, provides an iron core having a multiplicity of bobbins, secondly, adds an insulated shell body, thirdly, has each of the wire-winding bobbin having coil that is wound by enamel covered wire, and lastly, has the enamel-covered coil exteriorly pasted with tape. In this way, the common insulated structure of shield type motor coil is formed and placed in a mold body. Thereafter, plastics is injected in the mold body and the shell body of the insulated structure of shield type motor coil is formed.

As the above-mentioned plastics in the common insulated structure of shield type motor coil is made of thermosetting material, the following shortcomings in the manufacturing process can occur. Firstly, direct teeming of the plastics is apt to thrust off the enamel-covered coil. Secondly, the glass fiber contained in the plastics can damage the insulated enamel in the exterior layer covering the coil during the flowing of the casting plastic. Thirdly, deformation can be generated in the iron core subjected to the excessive pressure during the punch-cast forming process. All of these shortcomings of manufacturing process will result in the increase in NPL ratio and excessive scrap producing, and consequently, the raising of production cost.

Therefore, just how to resolve the above-mentioned problems and improve the design of the insulated structure of shield type motor coil has becomes necessary for the industry. This is the origin to have the present invention,

### SUMMARY OF THE INVENTION

In light of the above-mentioned disadvantages of the prior art, the invention provides “an insulated structure of shield type motor coil” that is capable of overcoming the shortcomings of the prior art, satisfying the requirements of the industry, as well as improving the competitiveness in the market. It aims to ameliorate at least some of the disadvantages of the prior art or to provide a useful alternative.

The primary objective of the invention is to provide “an insulated structure of shield type motor coil” to make use of a supporting frame for coating the protecting jacket, and also to provide a supporting frame that has a multiplicity of supporting posts which is capable of protecting the iron core from being damaged to generate deformation by the pressure during the teeming process into a mold, thereby to achieve a high efficacy of manufacturing yield.

To achieve the above-mentioned objectives, the insulated structure of shield type motor coil of the invention provides an insulated structure of shield type motor coil includes an iron core having a multiplicity of bobbins, at least a plastic shell having a multiplicity of insulators and is pressed against the iron core, a multiplicity of enamel-covered coils and each of the insulators is one-to-one correspondent to and pressed against the bobbin, a multiplicity of enamel-covered coils each of them is correspondent to and wound around the bobbin and the multiplicity of enamel-covered coils has a first connecting lead and a second connecting lead extended therefrom, a wire fastener secured in the plastic shell for holding the first connecting lead and the second connecting lead, a protecting jacket connected to the plastic shell and having a containing space for containing the multiplicity of enamel-covered coils, as well as a supporting frame for coating the protecting jacket and having a multiplicity of supporting posts thereof.

The accomplishment of the above-mentioned objectives of the invention will become apparent from the following description and its accompanied drawings of which:

### BRIEF DESCRIPTION OF THE DRAWINGS

FIG. 1 is a schematic-and-isometric view of the iron core structure of a preferred embodiment of the shield type motor of the invention;

FIG. 2 is a schematic-and-isometric view of the iron core structure having two plastic shell bodies of a preferred embodiment of the shield type motor of the invention;

FIG. 3 is a schematic-and-isometric view of the iron core structure wound by a multiplicity of enamel-covered coils of a preferred embodiment of the shield type motor of the invention;

FIG. 4 is a schematic-and-isometric view of the iron core structure with the multiplicity of enamel-covered coils having protecting outer jackets added of a preferred embodiment of the shield type motor of the invention;

FIG. 5 is a schematic-and-isometric view of the insulated structure of shield type motor coil of a preferred embodiment of the shield type motor of the invention.

### DETAILED DESCRIPTION OF THE PREFERRED EMBODIMENT

FIG. 1 is a schematic-and-isometric view of the iron core structure of a preferred embodiment of the shield type motor of the invention. As shown in FIG. 1, the insulated structure of shield type motor coil of the invention provides an iron core (1) which being made of high permeability material is manufactured by punching process and is stacked up by a plurality of iron core plates (1a). Each of the iron core plates (1a) has a plurality of bobbin plates (11a) which are stacked up to form a iron core (1) having a plurality of bobbins (11).

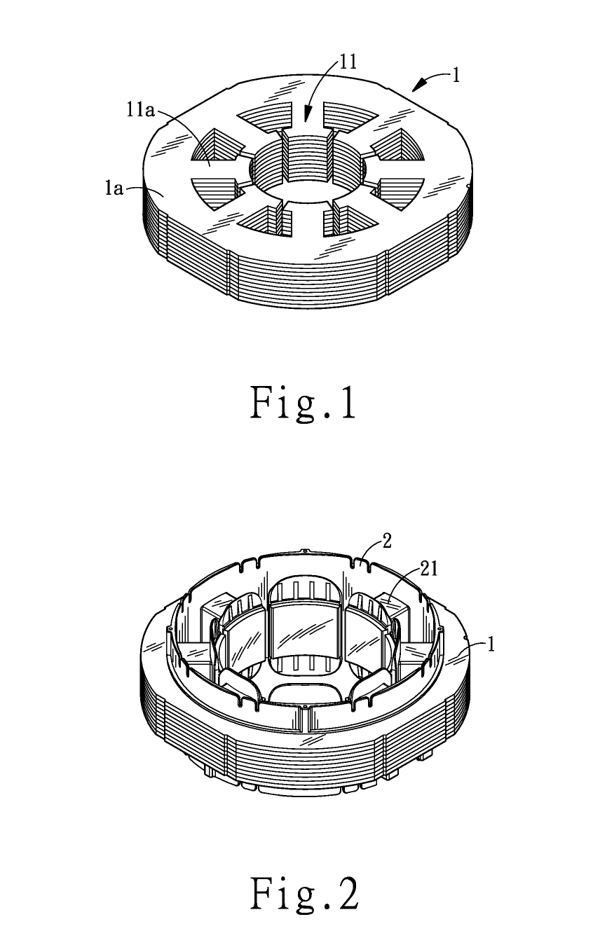

FIG. 2 is a schematic-and-isometric view of the iron core structure having two plastic shell bodies of a preferred embodiment of the shield type motor of the invention. As shown in FIG. 2, in the insulated structure of shield type motor coil of the invention, a plastic shell (2) being furnished and integrally formed on the exterior surface of the iron core (1) further has a plurality of insulators (21), each of which is one-to-one correspondent to and tightly pressed against the bobbin (11).

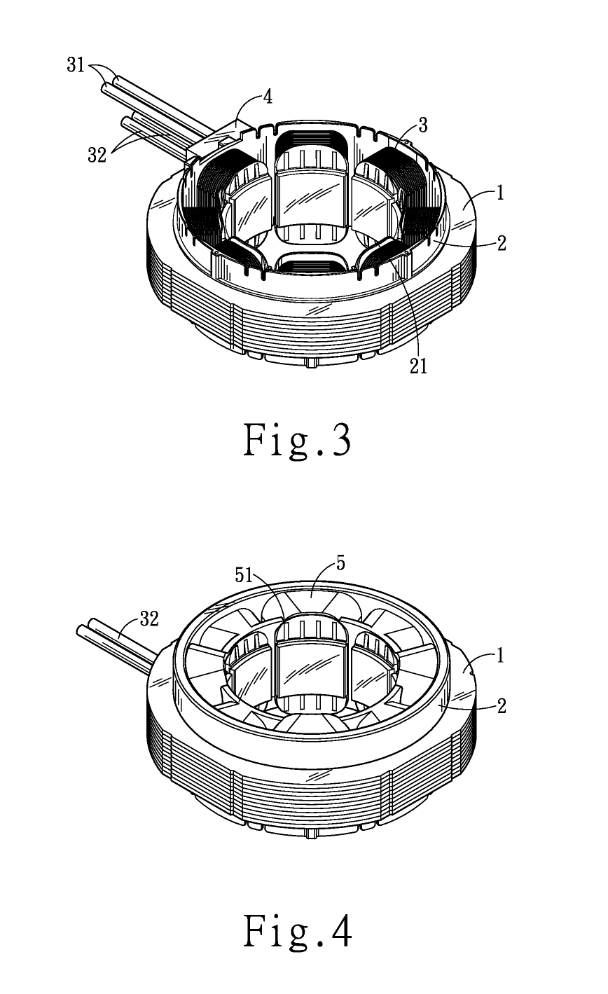

FIG. 3 is a schematic-and-isometric view of the iron core structure wound by a multiplicity of enamel-covered coils of a preferred embodiment of the shield type motor of the invention. As shown in FIG. 3, in the insulated structure of shield type motor coil of the invention, each of the insulators (21) of the plastic shell (2) is one-to-one correspondent to and is wound around by an enamel-covered coil (3) respectively. The plurality of enamel-covered coils (3) are mutually connected one another. A multiplicity of the enamel-covered coils (3) has a first connecting lead (31) and a second connecting lead (32) extended therefrom. In a preferred embodiment of the invention, a wire fastener (4) secured at the plastic shell (2) is also provided to bundle both the first connecting lead (31) and the second connecting lead (32) together.

FIG. 4 is a schematic-and-isometric view of the iron core structure with the multiplicity of enamel-covered coils having protecting outer jackets added of a preferred embodiment of the shield type motor of the invention. As shown in FIG. 4, a protecting jacket (5) covering the enamel-covered coil (3) is furnished. The protecting jacket (5) being connected to the plastic shell (2) has a containing space (51) for containing the multiplicity of enamel-covered coils (3). Moreover, the protecting jacket (5) being integrally formed and directly cast coats the iron core (1) that is furnished with enamel-covered coil (3) on the plastic shell (2).

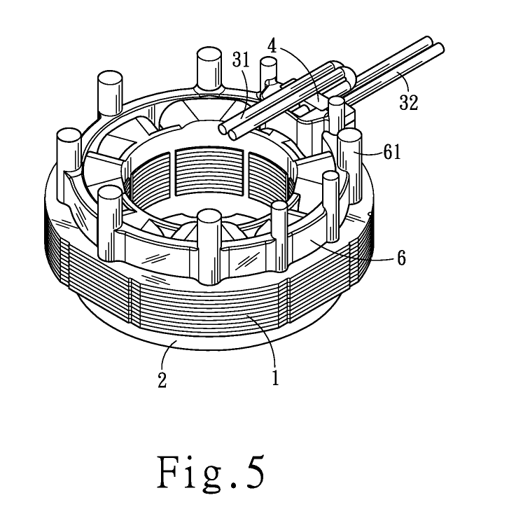

When it comes to assembling, the iron core (1) has a multiplicity of bobbins (11), the plastic shell (2) having a multiplicity of insulators (21) is pressed against the iron core (1), each insulator (21) of the plastic shell (2) is one-to-one correspondent to and pressed against the bobbin (11), each of the enamel-covered coil (3) is correspondent and wound around the insulator (21). Moreover, the multiplicity of enamel-covered coil (3) has the first connecting lead (31) and the second connecting lead (32) extend thereof, and has the wire fastener (4) hold both of the first connecting lead (31) and the second connecting lead (32), and also has the protecting jacket (5) connect to the plastic shell (2). What is more, the containing space (51) of the protecting jacket (5) contains the multiplicity of enamel-covered coils (3). Finally, as shown in FIG. 5, the protecting jacket (5) is coated by a supporting frame (6) which is strengthened by the multiplicity of supporting posts (61).

FIG. 5 is a schematic-and-isometric view of the insulated structure of shield type motor coil of a preferred embodiment of the shield type motor of the invention. As shown in FIG. 5, the insulated structure of shield type motor coil of the invention is firstly to put the iron core (1) having the protecting jacket (5) in to a mold (not shown in the Figure), then a first material of plastics that is used in the plastic shell (2) and the protecting jacket (5) is teemed in to melt together with the plastic shell (2) and the protecting jacket (5) to form the supporting frame (6) after cooling where a multiplicity of the supporting posts (61) is furnished in the supporting frame (6). As the first material of plastics is a thermosetting material, its flowing property is relatively better, thereby the frictional damage to the enamel-covered coil (3) is relatively less. Thereafter, a back-end manufacturers process is performed, i.e. since the second material of plastics is a thermosetting material, as the second material of plastics is teemed into the mold, the strength of the motor's outer shell is capable of achieving to meet the expected requirements. What is more, since the multiplicity of the supporting posts (61) is furnished in the supporting frame (6), to teem the second material of plastics into the mold will not cause the iron core (1) to deform, thereby the production yield can be improved.

It will become apparent to those people skilled in the art that various modifications and variations can be made to the structure of the invention without departing from the scope or spirit of the invention. In view of the foregoing description, it is intended that all the modifications and variation fall within the scope of the following appended claims and their equivalents.

What is claimed is:

1. An insulated structure of shield type motor coil, comprising:
an iron core having a plurality of bobbins;
at least a plastic shell having a multiplicity of insulators: the plastic shell is pressed against the iron core and each of the insulators is one-to-one correspondent and pressed against the bobbin;
a multiplicity of enamel-covered coils where each of them is one-to-one correspondent to and wound around the insulator, and each of the multiplicity of enamel-covered coils has a first connecting lead and a second connecting lead extended thereof;
a wire fastener securing in the plastic shell for holding the first connecting lead and the second connecting lead;
a protecting jacket connected to the plastic shell and having a containing space for containing the multiplicity of enamel-covered coil; and
a supporting frame coating the protecting jacket and having a multiplicity of supporting posts;
wherein, by making use of the iron core pressing against the plastic shell, each of the enamel-covered coils is correspondent to and wound around the insulator of the plastic shell, moreover, the wire fastener being secured in the plastic shell is provided for holding the first connecting lead and the second connecting lead, the protecting jacket is connected to the plastic shell, what is more, the containing space of the protecting jacket is for containing the multiplicity of enamel-covered coils, and the protecting jacket is coated by the supporting frame.

2. The insulated structure of shield type motor coil as claimed in claim 1, wherein the plastic shell is directly teemed on the iron core.

3. The insulated structure of shield type motor coil as claimed in claim 1, wherein the protecting jacket is directly teemed on the enamel-covered coil and the plastic shell.

4. The insulated structure of shield type motor coil as claimed in claim 1, wherein the supporting frame is made of thermosetting material.
